(19) United States
(12) Patent Application Publication
(10) Pub. No.: US 2014/0301603 A1
(43) Pub. Date: Oct. 9, 2014

(54) SYSTEM AND METHOD FOR COMPUTER VISION CONTROL BASED ON A COMBINED SHAPE

(71) Applicant: POINTGRAB LTD., Hod Hasharon (IL)

(72) Inventors: Eran EILAT, Givatayim (IL); Yonatan HYATT, Tel-Aviv (IL); Moshe NAKASH, Or Yehuda (IL); Ora ZACKAY, Beer Sheva (IL)

(73) Assignee: POINTGRAB LTD., Hod Hasharon (IL)

(21) Appl. No.: 14/248,388

(22) Filed: Apr. 9, 2014

Related U.S. Application Data
(60) Provisional application No. 61/810,059, filed on Apr. 9, 2013.

(51) Int. Cl. G06F 3/16; G06F 3/01; G06K 9/00

(52) U.S. Cl. CPC G06F 3/165; G06K 9/00355; G06F 3/017
USPC 382/103

(57) ABSTRACT

A method and system for computer vision based control of a device are provided in which a shape detection algorithm is applied on an image to identify in the image a finger positioned over or near a user's lips. A device may be controlled based on the detection of the shape, for example, a change of volume of an audio output of the device may be caused.

### CROSS-REFERENCE TO RELATED APPLICATIONS

This application claims the benefit of U.S. Provisional Patent Application No. 61/810,059, filed Apr. 9, 2013, which is hereby incorporated by reference.

### FIELD OF THE INVENTION

The present invention relates to the field of computer vision based control of electronic devices. Specifically, the invention relates to computer vision control of devices based on detection of specific shapes.

### BACKGROUND OF THE INVENTION

The need for more convenient, intuitive and portable input devices increases as computers and other electronic devices become more prevalent in our everyday life.

Recently, human hand gesturing and posturing has been suggested as a user interface input tool in which a hand movement and/or shape is received by a camera and is translated into a specific command Hand gesture and posture recognition enables humans to interface with machines naturally without any mechanical appliances.

Recognition of a hand gesture usually requires identification of an object as a hand and tracking the identified hand to detect a posture or gesture that is being performed. Tracking the identified hand may be used, for example, to move an icon or symbol on a display according to the movement of the tracked hand.

Some systems have been suggested which detect a user's hand and other body parts, such as detecting a user's face and a user's hand, typically to enhance the reliability of the system, to better identify the gesturing hand (e.g., by its location relative to the face) and to improve the viewing experience of the user (e.g., to align the viewed imaged based on the location of the user's head).

There are currently no systems that recognize and control a device based on a gesture that includes a combination of several body parts.

### SUMMARY OF THE INVENTION

Methods according to embodiments of the invention provide easy and intuitive control of a device based on the detection of a shape. In one embodiment the system applies a shape detection algorithm to detect the user's face and hand where the user places his finger over his lips in the intuitive and universal sign for “mute”. In one embodiment a single shape of combined body parts is detected, for example, the system may detect a shape of the combination of the user's face and hand where the user places his finger over his lips. The system may then control a device based on this detection.

Methods according to embodiments of the invention provide the advantage, among others, of allowing a user to control an electronic device by using universally known gestures, without being limited to hand gestures alone. Additionally, less computing power is needed than when separately identifying a hand and another body part and then deciding their relative position or tracking the hand on the background of another body part.

A limited number of detectors (possibly a single detector) may be thus used to quickly identify a gesture which combines a hand and other body part. Detectors and other modules when used herein may be for example software or code executed by processors, as described herein.

A method for computer vision based control of a device, according to one embodiment of the invention, includes obtaining an image of a field of view, the field of view comprising a user, and using a processor to detect a combined shape of at least a portion of the user's face and at least a portion of the user's hand; and to control the device based on the detection of the combined shape.

Detecting a combined shape may include running (e.g., executing on a processor) a detector that recognizes the shape of a combination of a face (at least a portion of the face, such as the user's lips and/or ear) and hand (at least a portion of the hand, such as one or more of the user's fingers). For example, the combined shape may include a finger positioned over or near the user's lips. In another embodiment the combined shape may include a finger positioned near the user's ear and a finger positioned near the user's lips.

Controlling the device may include causing a change of volume of an audio output of the device, for example, muting or unmuting the volume of the audio output of the device.

For example, detection of a combined shape which includes a finger positioned over or near the user's lips (the universal “mute” sign) may result in controlling the audio output of the device whereas detection of a combined shape which includes a finger positioned near the user's ear and a finger positioned near the user's lips (the universal “on the phone” sign) may result in running (e.g., executing using a processor) a communication related program on the device.

In one embodiment a user's face is detected and the size, location or both size and location of the user's face may be determined The determined size and/or location may then be used to detect the combined shape.

In one embodiment the method includes indicating to the user when the combined shape is detected, for example, by displaying an indication on a display of the device.

In one embodiment the device may be controlled by detection of the combined shape and then detection of the absence of the combined shape. For example, the method may include muting or unmuting an audio output of a device based on the detection of the combined shape and unmuting or muting the audio output based on the detection of the absence of the combined shape.

In one embodiment the method includes obtaining an image of a field of view, the field of view comprising a user; applying (e.g., executing using a processor as disclosed herein) a shape detection algorithm to identify in the image a finger positioned over or near the user's lips; and causing a change of volume of an audio output of the device (e.g., muting or unmuting) based on the identification of the finger positioned over or near the user's lips in the image.

A system for computer vision based control of a device, according to an embodiment of the invention may include a processor to detect in an image a combined shape of at least a portion of the user's face and at least a portion of the user's hand and to generate a signal to control a device based on the detection of the combined shape. For example, the portion of the user's face may include the user's lips and the portion of the user's hand may include one or more of the user's fingers.

The device, which may be part of the system, may include a display and the processor may cause an indication to be displayed on the display based on the detection of the combined shape.

### BRIEF DESCRIPTION OF THE FIGURES

The invention will now be described in relation to certain examples and embodiments with reference to the following illustrative figures so that it may be more fully understood. In the drawings:

FIGS. 1A and 1B schematically illustrate methods for computer vision based control of a device according to an embodiment of the invention;

FIG. 1C schematically illustrates a system according to an embodiment of the invention;

FIG. 2A schematically illustrates a combined gesture for “mute”, according to one embodiment of the invention;

FIG. 2B schematically illustrates a combined gesture for “call”, according to one embodiment of the invention;

FIG. 3 schematically illustrates a method for computer vision based control of a device according to another embodiment of the invention; and

FIG. 4 schematically illustrates a method for computer vision based control of a device based on the detection of a combined gesture and the detection of its absence, according to an embodiment of the invention.

### DETAILED DESCRIPTION OF THE INVENTION

Embodiments of the present invention provide computer vision based control of a device which is intuitive for the user and less burdensome for the processing system than currently existing methods of control.

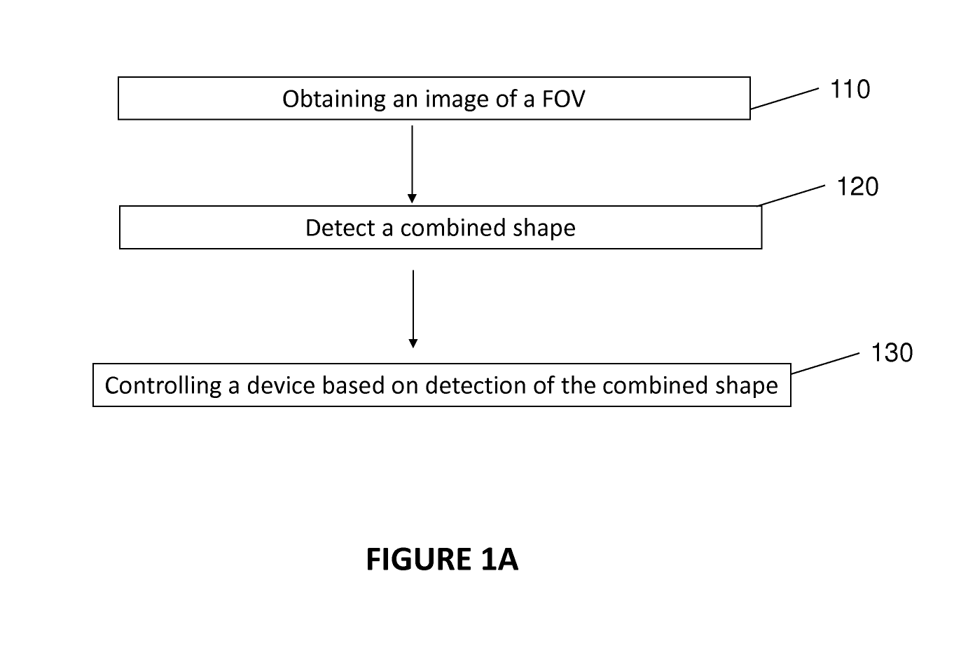

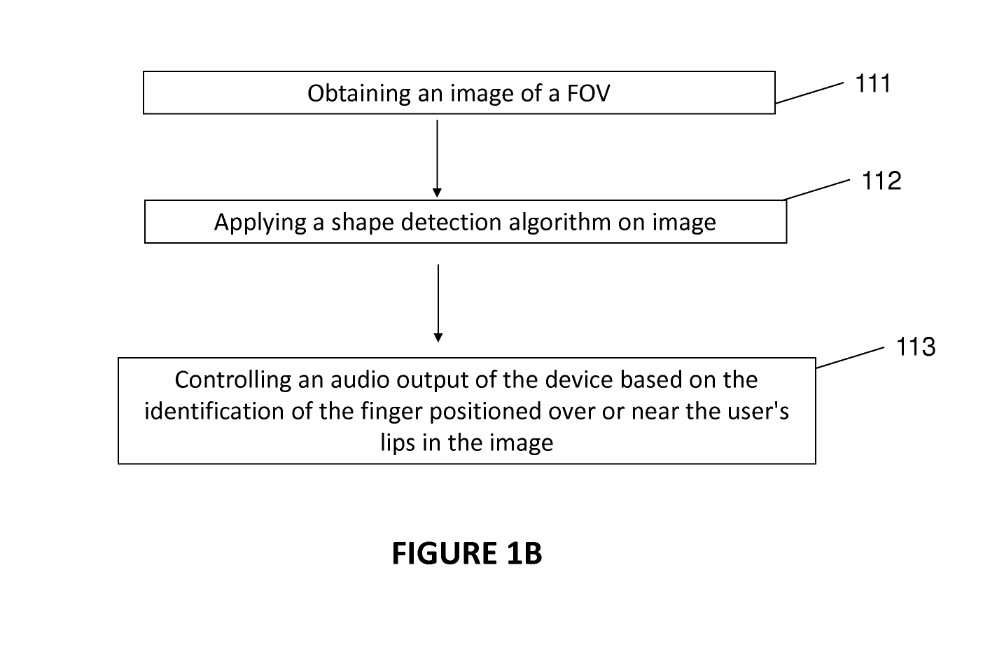

A method for computer vision based control of a device, according to one embodiment of the invention, is schematically illustrated in FIG. 1A. According to one embodiment the method includes obtaining an image of a field of view (110) the field of view including a user (“user” may include also partial views of the user); detecting a combined shape of the user's face and hand (120) (“face” and “hand” may include also partial view of a face or a hand or portions of the face and/or hand); and controlling the device based on the detection of the combined shape (130).

A method for computer vision based control of a device according to another embodiment of the invention is schematically illustrated in FIG. 1B. According to one embodiment the method includes obtaining (e.g., using an imager to capture) an image of a field of view which includes a user (111); applying a shape detection algorithm to identify in the image a finger positioned over or near the user's lips (112); and controlling an audio output of the device (such as causing a change (e.g., change of volume) in an audio output of the device) based on the identification of the finger positioned over or near the user's lips in the image (113).

According to another embodiment a communication related program may be run based on the identification of the finger positioned over or near the user's lips in the image.

Typically, methods according to embodiments of the invention are carried out on a system, such as the system schematically illustrated in FIG. 1C.

The system 800 may include an image sensor 803, typically associated with a processor 802, memory 82, and a device 801. The image sensor 803 sends the processor 802 image data of field of view (FOV) 804 to be analyzed by processor 802. FOV 804 typically includes a user.

Typically, image signal processing algorithms and/or image acquisition algorithms may be run in processor 802. According to one embodiment a signal to control the device 801 is generated by processor 802 or by another processor, based on the image analysis, and is sent to the device 801. According to some embodiments the image processing is performed by a first processor which then sends a signal to a second processor in which a control command is generated based on the signal from the first processor.

Processor 802 may include, for example, one or more processors and may be a central processing unit (CPU), a digital signal processor (DSP), a microprocessor, a controller, a chip, a microchip, an integrated circuit (IC), or any other suitable multi-purpose or specific processor or controller.

According to one embodiment processor 802 (or another processor) is in communication with the device 801 and may detect a combined shape of at least part of the user's face and at least part of the user's hand.

The device 801 may be any electronic device that can accept user commands, e.g., TV, DVD player, PC, mobile/smart phone, camera, set top box (STB) etc. According to one embodiment the device 801 may include an audio system and/or may run a communication related program. According to one embodiment, device 801 is an electronic device available with an integrated standard two dimensional (2D) camera or imager. The device 801 may include a display 81 or a display may be separate from but in communication with the device 801.

According to one embodiment control of the device may include changes on the display 81. For example, based on detection of the combined shape an indication (such as appearance or disappearance of an icon or change of characteristics of the display such as color or brightness or transparency changes of portions of the display) may be displayed on the display of the device.

Memory unit(s) 82 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

The processor 802 may be integral to the image sensor 803 or may be a separate unit. Alternatively, the processor 802 may be integrated within the device 801. According to other embodiments a first processor may be integrated within the image sensor and a second processor may be integrated within the device.

The communication between the image sensor 803 and processor 802 and/or between the processor 802 and the device 801 may be through a wired or wireless link, such as through infrared (IR) communication, radio transmission, Bluetooth technology or other suitable communication routes.

According to one embodiment the image sensor 803 may include a CCD or CMOS or other appropriate chip. The image sensor 803 may be included in a camera or imager such as a forward facing camera, typically, a standard 2D camera such as a webcam or other standard video capture device, typically installed on PCs, smartphones or other electronic devices. A 3D camera or stereoscopic camera may also be used according to embodiments of the invention. Image sensor 803 may capture images to obtain images. Images may be received at processor 803 for processing.

According to some embodiments image data may be stored in processor 802, for example in a cache memory. Processor 802 can apply image analysis algorithms, such as motion detection and shape recognition or detection algorithms to identify and further track the user's hand.

An identified hand and/or face may be tracked by the system. In some embodiments a signal to control a device may be generated based on identification of a combined shape and based on identification of a movement of the user's hand in a specific pattern or direction based on the tracking of the hand. A specific pattern of movement may be for example, a repetitive movement of the hand (e.g., wave like movement). Alternatively, other movement patterns (e.g., movement vs. stop, movement to and away from the camera) or hand shapes (e.g., specific postures of a hand) may be used to control the device.

However, in some embodiments of the invention applying shape detection algorithms to detect a combined shape rather than or without tracking a user's hand to detect a gesture enables detecting a user making a “mute” gesture, a “call” gesture or other gestures, even in a single image.

Processor 802 may perform methods according to embodiments discussed herein by for example executing software or instructions stored in memory 82.

According to one embodiment shape detection algorithms may be stored in memory 82. A combined shape (as well as a shape of a hand and/or a face) may be detected, for example, by applying a shape recognition algorithm (for example, an algorithm which calculates Haar-like features in a Viola-Jones object detection framework and/or Intel's OpenCV). Machine learning techniques may also be used in identification of specific, predefined shapes, such as a shape of a combination of hand and other body part, such as a portion of a hand and a portion of a face.

When discussed herein, a processor such as processor 802 which may carry out all or part of a method as discussed herein, may be configured to carry out the method by, for example, being associated with or connected to a memory such as memory 82 storing code or software which, when executed by the processor, carry out the method.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

Referring to the method schematically illustrated in FIG. 1A, the system may detect a combined shape by running a single detector that recognizes the shape of the combination of a face (or part of a face) and hand (or part of a hand) (e.g., as opposed to recognizing each of the hand and face separately). According to other embodiments several detectors may be used to identify the combined shape.

A combined shape, according to embodiments of the invention may include a portion of the user's face and at least a portion of the user's hand.

In some embodiments the system may apply shape detection algorithms. For example, an algorithm for calculating Haar features may be used to identify each of a hand or a portion of a hand and/or a face or portion of a face, typically separately. The identified portions may then be tracked and their relative position may be determined to detect a combined gesture of all body parts or body part portions.

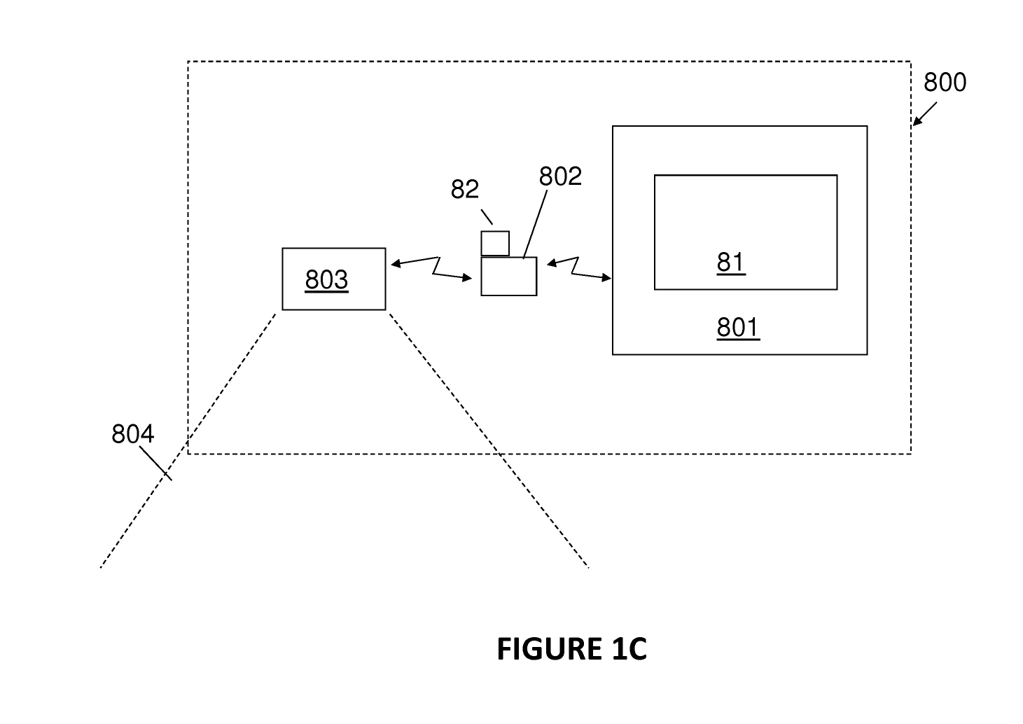

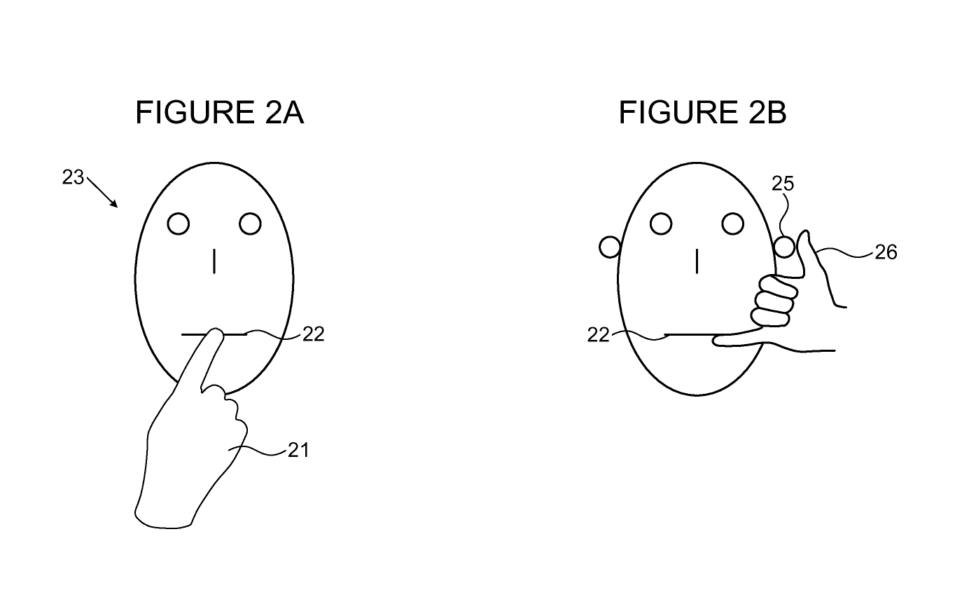

In one embodiment, which is schematically illustrated in FIG. 2A, the combined gesture performed by a user is a “mute” or “silence” gesture which includes a combined shape including at least the user's lips (22) and does not necessarily include the full face (23) of the user. According to one embodiment the combined shape includes a finger (21) positioned over or near the users' lips (22).

According to one embodiment, detection of a combined “mute” shape (such as illustrated in FIG. 2A) results in controlling a device (e.g., a music playing device, smart phone or TV set) such that a change of volume of the audio output of the device is caused, for example, muting or unmuting the audio output of the device.

According to another embodiment, which is schematically illustrated in FIG. 2B, the combined shape is a “call” gesture which includes a finger (typically the thumb (26)) positioned near the user's ear (25) and a finger (typically the smallest finger furthest from the thumb) positioned near the user's lips (22).

According to one embodiment, detection of the “call” combined gesture illustrated in FIG. 2B, results in controlling a device (e.g., a PC or smart phone) to run a communication related program, such as to place a call to another device.

Other commands may be generated based on these combined gestures. Other combined gestures may be similarly detected and used to control a device.

According to some embodiments a signal to control a device may be generated based on analysis of a single image.

Detecting a combined shape, such as the combined shapes described above, may include a detector or other software or processor identifying the combined shape by applying computer vision algorithms, such as by applying shape detection and/or comparing the detected shape to a database of pre-provided examples. Image data from each image in which the shape is detected may then be used to update the database using machine learning techniques.

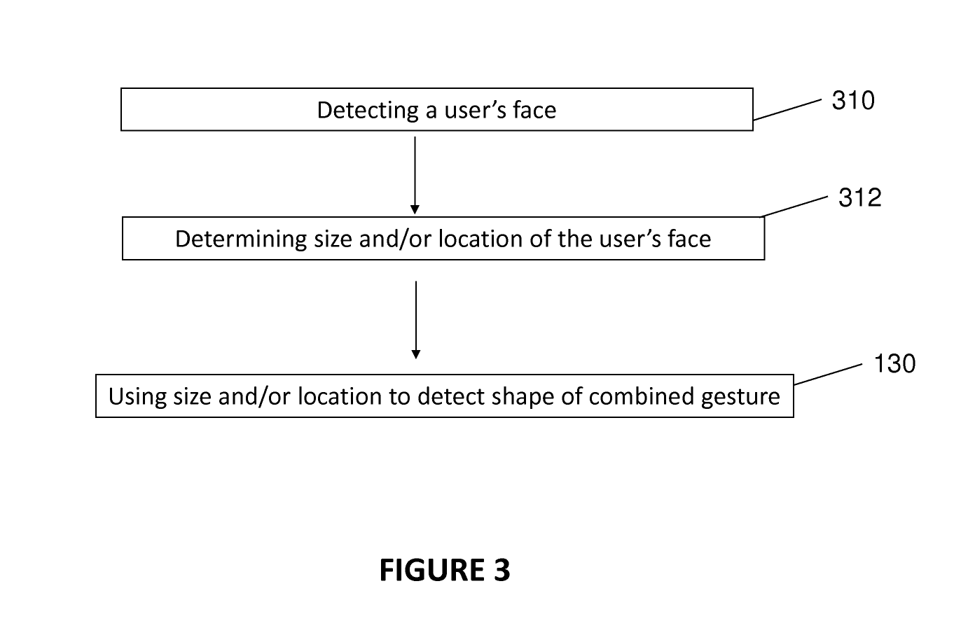

According to another embodiment which is schematically illustrated in FIG. 3, detecting the shape of the combined gesture may include detecting the user's face (310); determining the size and/or location of the user's face (312); and using the size and/or location of the user's face to detect the combined shape of the user's face and hand (314).

A face or facial landmarks may be continuously or periodically searched for in the images and may be detected, for example, using known face detection algorithms (e.g., using Intel's OpenCV). According to some embodiments a shape can be detected or identified in an image, as the combined shape, only if a face was detected in that image. In some embodiments the search for facial landmarks and/or for the combined shape may be limited to a certain area in the image (thereby reducing computing power) based on movement detection (an area in which movement (e.g., movement having specific characteristics) has been detected), on size (limiting the size of the searched area based on an estimated or average face size or based on the determination of the user's face size), on location (e.g., based on the expected location of the face) and/or on other suitable parameters.

Thus, in some embodiments, the method for computer vision based control of a device may include using a processor to detect a face in an image (and possibly determining parameters such as described above) and only if a face is detected in the image then the processor (or another processor) may be used to detect the combined shape. Possibly, the detection of the combined shape may be assisted by taking into account determined parameters).

In some embodiments the method may include indicating to the user when the combined shape is detected so as to give the user feedback regarding his operation of the device. The indication to the user may include displaying an indication on a display of the device (e.g., showing a new icon or changing characteristics such as color or brightness or transparency of an icon or portion of the display), using a sound or vibration or other such signal.

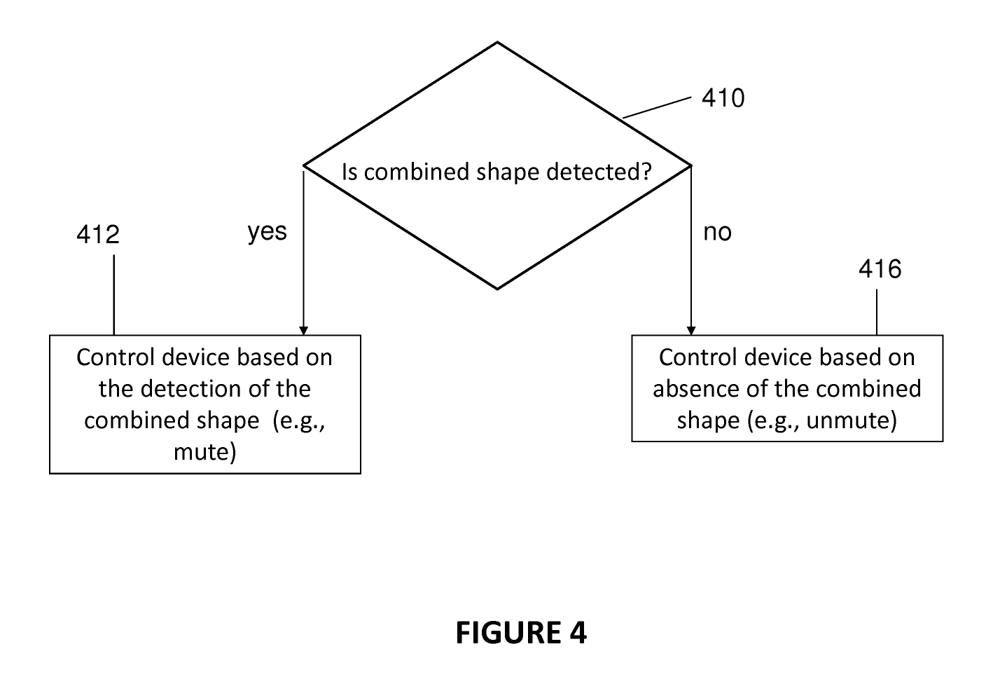

According to one embodiment, which is schematically illustrated in FIG. 4, as long as the combined shape is detected (410) the device is controlled based on the detection of the combined shape (412) (either muted or unmuted or otherwise controlled), however, once an absence of the combined shape is detected (or the combined shape is no longer detected) the device is controlled based on the detected absence (416).

Thus, according to one embodiment, the device is controlled based on the detection of the combined shape and on the subsequent detection of the absence of the combined shape. Possibly, after a pre-determined delay following the detection of absence of the combined shape, the system may again launch a search for the combined shape.

For example, a device may be muted (or unmuted or a communication related program may be initiated or the device may be otherwise controlled) based on the detection of the combined shape (e.g., a finger over a user's lips) and once the user has removed his hand the device may be unmuted (or muted or the communication related program may disconnect a call or otherwise controlled) based on the detection of the absence of the combined shape.

1. A method for computer vision based control of a device, the method comprising:
obtaining an image of a field of view, the field of view comprising a user;
using a processor to detect a combined shape of at least a portion of the user's face and at least a portion of the user's hand; and
using the processor to control the device based on the detection of the combined shape.

2. The method of claim 1 wherein detecting the combined shape comprises running a detector that recognizes the shape of a combination of a face and hand.

3. The method of claim 1 wherein the portion of the user's face comprises the user's lips.

4. The method of claim 1 wherein the portion of the user's hand comprises a finger.

5. The method of claim 1 wherein the combined shape comprises a finger positioned over or near the user's lips.

6. The method of claim 1 wherein the combined shape comprises a finger positioned near the user's ear and a finger positioned near the user's lips.

7. The method of claim 1 wherein controlling the device comprises causing a change of volume of an audio output of the device.

8. The method of claim 7 wherein controlling the device comprises muting or unmuting the volume of the audio output of the device.

9. The method of claim 6 wherein controlling the device comprises running a communication related program.

10. The method of claim 1 comprising:
using the processor to:
detect the user's face;
determine a size, location or both of the user's face; and
use the size, location or both of the user's face to detect the combined shape.

11. The method of claim 1 comprising indicating to the user when the combined shape is detected.

12. The method of claim 11 wherein indicating to the user comprises displaying an indication on a display of the device.

13. The method of claim 1 comprising:
using the processor to:
detect the combined shape;
detect absence of the combined shape; and
control the device based on the detection of the combined shape and based on the absence of the combined shape.

14. The method of claim 13 wherein controlling the device comprises muting or unmuting an audio output of the device based on the detection of the combined shape and muting or unmuting the audio output based on the detection of the absence of the combined shape.

15. A method for computer vision based control of a device, the method comprising:
obtaining an image of a field of view, the field of view comprising a user;
applying a shape detection algorithm to identify in the image a finger positioned over or near the user's lips; and
controlling an audio output of the device based on the identification of the finger positioned over or near the user's lips in the image.

16. The method of claim 15 wherein controlling the audio output comprises muting or unmuting the audio output of the device.

17. The method of claim 15 wherein applying a shape detection algorithm comprises detecting a combined shape of the user's face and hand.

18. A system for computer vision based control of a device, the system comprising:
a memory; and
a processor to detect in an image a combined shape of at least a portion of the user's face and at least a portion of the user's hand and to generate a signal to control a device based on the detection of the combined shape.

19. The system of claim 18 comprising the device, said device comprising a display wherein the processor is to cause an indication to be displayed on the display based on the detection of the combined shape.

20. The system of claim 18 wherein the processor is to apply a shape detection algorithm to detect the combined shape and wherein the portion of the user's face comprises the user's lips and wherein the portion of the user's hand comprises the user's finger.
